(19) United States
(12) Patent Application Publication
(10) Pub. No.: US 2024/0378600 A1
(43) Pub. Date: Nov. 14, 2024

(54) METHODS AND SYSTEMS FOR FORMATION AND TERMINATION OF PAYMENT CHANNEL BETWEEN DISTINCT LEDGERS

(71) Applicant: INDIAN INSTITUTE OF TECHNOLOGY BOMBAY, Mumbai (IN)

(72) Inventors: Siddharth Nimeshbhai MAURYA, Mumbai (IN); Vinay Joseph RIBEIRO, Mumbai (IN); Umesh Rama Rao BELLUR, Mumbai (IN)

(73) Assignee: INDIAN INSTITUTE OF TECHNOLOGY BOMBAY, Mumbai (IN)

(21) Appl. No.: 18/598,666

(22) Filed: Mar. 7, 2024

(30) Foreign Application Priority Data
May 8, 2023 (IN) 202321032553

(51) Int. Cl. G06Q 20/38; G06Q 20/06; G06Q 20/10; G06Q 20/36; G06Q 20/40; G06Q 20/42

(52) U.S. Cl. CPC G06Q 20/389; G06Q 20/06; G06Q 20/10; G06Q 20/367; G06Q 20/3825; G06Q 20/3827; G06Q 20/388; G06Q 20/4016; G06Q 20/42

(57) ABSTRACT

Embodiments herein disclose a formation and termination mechanism for a general-purpose Cross-Chain Payment Channel (CCPC) protocol, wherein the CCPC protocol can execute fund transfers between two accounts residing in different blockchains off-chain by building a payment channel between the two accounts and breaking down the funding and withdrawal transactions into multiple transactions. Embodiments herein disclose a formation and termination mechanism for a general-purpose Cross-Shard Payment Channel (CSPC) protocol in a sharding system to perform cross-shard transactions, wherein a payment channel is built between accounts from two shards, which would dramatically reduce the number of actual cross-shard transactions recorded at the layer 1 blockchain, resulting in lower latency of cross-shard transactions, as compared to existing sharding schemes.

### CROSS REFERENCE TO RELATED APPLICATION

This application is based on and derives the benefit of Indian Provisional Application 202321032553, the contents of which are incorporated herein by reference.

### TECHNICAL FIELD

Embodiments disclosed herein relate to blockchain based currency protocol, and more particularly to formation and termination mechanisms for a general-purpose Cross-Chain Payment Channel (CCPC) protocol and a general-purpose Cross-Shard Payment Channel (CSPC).

### BACKGROUND

The Bitcoin protocol establishes a trustless decentralized network for maintaining a unique currency ledger. However, its Proof-of-Work (PoW) consensus algorithm, while enabling decentralization, limits scalability due to its performance constraints. Byzantine Fault Tolerance (BFT) algorithms are not suitable for large-scale networks due to high message complexity. Sharding is proposed as a scalability solution but introduces latency challenges.

A blockchain operates as a distributed state machine, where transactions change the system's state. It maintains a ledger with a sequence of blocks, each linked to the previous one, ensuring immutability. Consensus algorithms are crucial for maintaining a consistent state across all nodes. In permissioned networks, PBFT-like algorithms work well, while open networks require PoW for consensus. PoW is scalable due to its low message complexity but faces throughput limitations.

To address scalability issues, payment channels, like the Lightning Network, operate off-chain and offer high-speed transactions. Sharding aims to scale layer 1 blockchains but faces challenges with cross-shard transactions. Dynamic sharding and account segmentation are proposed to optimize shard assignment. Cross-chain bridges facilitate asset transfers between different blockchains, but some rely on centralized custodians.

### Blockchain in a Distributed State Machine:

A state machine has a state at a given point in time, wherein each new transaction performed on this state machine basically attempts to change the state of the machine. The current state of a machine is a result of past transactions, the next state of the machine will be a function of the current state and new transaction. In a distributed system, a state machine has to be consistent across all nodes.

Essentially, a blockchain based system is a replicated state machine. In blockchain based currency, states are basically balances of different accounts on the blockchain. Each new block introduces new transactions and each new transaction updates the state of the system. Blockchain basically stores a list of transactions in a sequence. Each block is connected to the previous block by storing its hash. Such a hash chain structure makes the blockchain immutable.

FIG. 1 depicts a blockchain 102 and state machine 104, wherein the current state 106 of the system is represented with Sₖ. The current State 106 of the machine states that user x has 10 ETH coins and user y has 20 ETH coins. This state can only be changed by performing a transaction on this state machine. A list of such transactions is maintained in a blockchain. In FIG. 1, the execution of the last transaction from the blockchain is illustrated. The transaction Tₘ is essentially a fund transfer transaction from y to x. The state transition function 108 takes the current state 106 and new transaction as input and returns a new state of the system.

### Consensus:

Just building a working state machine is not enough for a decentralized system. Unless every node in the network has the same transaction logs, no one would have the same state in their machine. Transaction log means the blockchain itself. Hence, a method is required to reach an agreement on a common blockchain for everybody. This problem gets harder as byzantine nodes (or malicious) have to be introduced into the network, which can lie to other nodes about blocks. In presence of byzantine nodes, achieving consensus is difficult and several algorithms have been each having its own trade-off.

### Permissioned Network:

Different kinds of network environments would need a different kind of consensus algorithm. In a permissioned network, where the identities of every node are known beforehand, PBFT (Practical Byzantine Fault Tolerance) like algorithms can be used to achieve consensus on any data. PBFT achieves consensus on data by broadcasting messages to the network in multiple rounds by all nodes. Consensus is achieved when nodes receive confirmations in the form of a quorum. PBFT requires static nodes and node identities to be known. Though byzantine is fault tolerant, it has quadratic messaging complexity (O(i where n is the number of nodes in the network) which works well up to a few 100 nodes, but becomes impractical if thousands of nodes are involved.

### Permissionless Network:

In an open network, where the identities of nodes are not known and any number of nodes can join and leave, PBFT does not work. Nakamoto consensus involving Proof-of-Work (PoW) can be used in this setting. Using PoW for consensus is a radically different technique than message passing based consensus. Achieving consensus basically means that, all honest nodes of the network agree on the same blockchain. To achieve that using the Nakamoto consensus protocol, every node should accept the first new block they see having a valid PoW. PoW refers to a solution for a cryptographic puzzle that requires significant computational power. The idea behind the protocol is that the person spending such an amount of power should be a legitimate person. Also, since high computational power is a barrier to proposing a new block, the PoW protocol is also Sybil-resistant.

Message complexity is irrelevant to the number of nodes in PoW consensus, so it can work with a very large number of nodes without congesting the network. Due to the protocol scheme, everyone in the network is allowed to propose a block. The difficulty of the puzzle has to be set hard enough so that the inter-arrival time of a block stays moderate to avoid forking. This is exactly what causes a bottleneck in the scalability of the PoW blockchain system.

### Scalability Limitations:

The Bitcoin blockchain has 10 minutes of inter-arrival time and 1 MB of average block size. This configuration results in a throughput of 4-7 transactions per second. This value is really low compared to the transaction throughput of centralized currencies managed by companies like Visa, which has an average throughput of 1700 transactions per second. For cryptocurrency to be practical as a centralized currency, the blockchain has to somehow scale to that level.

Naive ideas to scale the PoW chain are to either increase the block size or to decrease the inter-arrival time of the block. Decreasing the inter-arrival time of blocks means decreasing the difficulty of the PoW puzzle, this will result in block generation faster while generating more forks 202 (FIG. 2 illustrates forking in a blockchain), as more people will be having valid PoW to show at the same level. On the other hand, increasing block size means a higher propagation delay. This means, there will be miners who will continue mining a block at some level even though a block has already been created somewhere in the network, but the miner will not be aware of it for a long duration due to the high propagation delay of the heavy block. This will again result in higher forking, which is undesirable.

BFT consensus algorithms, on the other hand, rely on inter-node communication to reach consensus. Though this achieves slightly better throughput than PoW chains, it is not scalable as more nodes join the network. The BFT protocol fails due to quadratic message-passing complexity. Hence, it could not be used for an open network like Bitcoin has.

This high number of network nodes and transaction throughput trade-off is basically what the scalability issue is. In PBFT we can have fairly high throughput, but we can't have a high number of nodes participating in the network. PBFT-based consensus may have 100-200 nodes. In PoW consensus, a high throughput cannot be obtained, but a very large number of nodes can be present. A truly scalable blockchain system should have higher throughput as the number of nodes increases in the network.

### Sharding:

Use of sharding to scale a single common blockchain hypothetically would eventually hit the physical limits of the internet network. The root of the problem of the single blockchain approach is that every node in the network stores and processes the exact same transactions. This replication becomes the bottleneck for scalability. This section goes through the basic idea of sharding in blockchain, how it is inspired by database sharding, and its major challenges.

### Database Sharding:

Sharding has been used for databases generally to divide a load of requests to multiple servers by achieving horizontal scalability. It does so by partitioning different sets of rows of a table into multiple tables. Now, these multiple tables can be stored independently in multiple servers and all of these servers can now process user requests in parallel which results in higher throughput. Sharding in Blockchain takes a similar idea from this and applies it to scale the blockchain system.

### Sharding in Blockchain:

FIG. 3 depicts the concept of blockchain sharding. A standard blockchain system maintains a single common blockchain suffers scaling issue due to replication on all nodes. Whether there are 100 nodes or 1 million nodes, all shall have the same blockchain generating blocks at the same rate. To circumvent this, the idea of Sharding blockchain is to run parallel blockchains containing different sets of accounts independently. If a Blockchain runs at k transactions per second, N similar Blockchains running in parallel would have a throughput of N times k transactions per second 302. For example, if a blockchain runs at 7 transactions per second, two similar blockchains running in parallel would have effective throughput of 14 transactions per second.

Defining shard assignments for nodes in a permissionless network is a challenge. There has to be a mechanism to assign nodes to some shard. We would want such a mechanism to be as random as possible, if not, adversaries could collude to achieve more than 50% fraction of a shard. Achieving such public randomness is generally hard. Another major challenge of the sharded blockchain system are cross-shard transactions.

### Cross-Shard Transactions:

One of the major challenges for blockchain sharding is the execution of cross-shard transactions. In such sharded systems, disjoint states are stored in different blockchains. If the input ID from shard A wants to perform a transaction to output ID from shard B, there has to be a protocol to safely execute such transactions. Existing solutions to execute these transactions while maintaining consistency essentially involves a two-phase commit technique which turns out be slower than the execution of regular intra-shard transactions.

A naive approach to minimize the fraction of cross-shard transactions is to shard accounts optimally based on their past interactions with other accounts. This will not work in real-world scenarios as even with optimal sharding based on past transactions observed among accounts in the history of the Ethereum blockchain, a high fraction of cross-shard transactions is observed.

A current solution has computed optimal sharding for 6 shards based on the Ethereum transaction history of 4000 blocks starting from 7.3 millionth blocks. It achieves 30% cross-shard fraction. The timespan for these 4000 blocks in Ethereum is about 15 hours, and hence this resulting optimal cross-shard fraction might not be the true representative of real-world usage.

Another sharding blockchain solution computes optimal sharding using METIS using the history of Ethereum transactions from a roughly 6 months window (August '15 to February '16), which found out the cross-shard fraction to be 83% for 64 shards and about 75% for 32 shards.

Moreover, it can now be observed that the fraction of cross-shard transactions will inevitably increase as the number of shards increases regardless of how the accounts can be distributed optimally in appropriate shards. This also shows a limitation of the sharding mechanism for scalability. The maximum number of shards possible is equal to the total number of accounts, at which the cross-shard transaction fraction would be 100%.

Various approaches have been attempted to scale a single common blockchain to achieve higher throughput and computation capacity of smart contracts. A physical limit of performance of a single blockchain can be reached due to network latency and link capacity. The sharding approach can potentially scale the system beyond this physical limit.

### Two Phase Commit:

A Two Phase Commit protocol, a blockchain sharding protocol achieves sharding in terms of transaction computation by allowing parallel execution of transactions in different shards, but does not achieve sharding in terms of space as each node has to maintain the same global blockchain. Hence does not count as a full-sharding method as it does not need to deal with cross-shard transactions as all shard maintains a global blockchain.

### Omniledger:

Another solution proposes a full sharding mechanism for a permissionless blockchain system, however, this would necessarily require a mechanism to atomically execute cross-shard transactions. An Atomix Protocol has been proposed, which achieves this using a two-phase commit technique.

FIG. 4 depicts the Atomix protocol. The mechanism of Atomix Protocol is as follows: at step 402, the client generates a cross-shard transaction and sends it to shards relevant to inputs of the transaction, wherein these input shards send proof of validity to the client and lock the respective input address in input shards. At step 404, once the client receives validity proof from all input shards, the client sends the cross-shard transaction to output shard(s) along with the validity proof. Once the output shard(s) accepts the transaction, at step 406, input shards would unlock the address and, at step 408, the input shards would commit the cross-shard transaction. In case of rejection, locked addresses in input shards are unlocked and the transaction is aborted. This process is called Two Phase commit as tokens have to be locked in input shards in the first phase and then this commit has to be conveyed to output shards in the second phase. It is evident that this process would result in much higher latency than an intra-shard transaction, which would simply require a single transaction to be committed on the blockchain to complete.

Another solution proposes a similar two-phase commit technique to execute cross-shard transactions involving relay transactions on PoW Shards. In essence, the high latency of cross-shard transactions and an inevitably high fraction of cross-shard transactions is the core problem of the Blockchain Sharding system in terms of scalability.

### Dynamic Sharding:

The majority of existing blockchain sharding protocols assumes static sharding. That means once accounts are assigned to a shard they would stick to the shard forever. Another solution introduces a different approach to sharding, and this section discusses this briefly.

### Mitosis:

Shards could be dynamically changed to minimize cross-shard trans-actions. A solution proposes a protocol for chain splitting and chain fusion in a permissioned sharding system (hereinafter referred to as mitosis). The solution uses a central registry to keep track of the current sharding status across all shards. Though, the solution defines a mechanism to dynamically resize shards, It does so at the will of nodes of relevant shards. Hence the protocol does not enforce particular sharding to achieve optimal cross-shard fraction. Even if the protocol dynamically enforces changing shards based on some optimal partitioning of the account interaction graph with the hope of reducing the cross-shard fraction, a significantly high cross-shard fraction would hit them anyways based on observation(s). Also, the cross-shard transactions are handled in a similar two-phase manner which would eventually bring the system to the same scalability issue as observed in other sharding systems.

### Account Segmentation:

FIGS. 5A and 5B depict a comparison of the standard sharding scheme and mitosis. Accounts being fixed in a particular shard is a core reason for cross-shard transactions to occur as discussed earlier. A caveat of Mitosis was that shard nodes were allowed to split or merge multiple shards at their will without any protocol or heuristic guiding them. This problem is further explored by BrokerChain, which proposes an account segmentation technique. BrokerChain approaches this problem by proposing a protocol for balance-state sharding in the blockchain. This way the account itself could be segmented into multiple shards. This segmentation is done by calculating an optimal graph based on past transaction histories of accounts. This method aims to reduce the cross-shard fraction to improve the performance of the system.

As shown in FIG. 5A, mitosis enables division of a parent chain 502 to give birth to new chains, called child chains 504. Mitosis lets the various blockchains self-organize and dynamically create new sibling chains, as per the need. In contrast, as shown in FIG. 5B, in the existing sharding solutions, “parallel processing” translates to the various shards 506 splitting the load of transaction processing under the same consensus.

FIG. 6 depicts a visualization of the account segmentation technique. If account C owns 10 tokens, it can be segmented into two accounts C1 and C2, where C1 and C2 own 5 tokens each. Account C1 would exist in shard 1 and account C2 would exist in shard 2. This allows account C to perform cross-shard transactions without actually needing to perform actual cross-shard transactions. Though this seems promising, the reduction of the cross-shard fraction in their experiments is not as significant enough to eliminate the problem of cross-shard transactions. FIGS. 7A and 7B depict the results of BrokerChain with 64 shards and 32 shards respectively.

### Payment Channel:

Payment Channel is another radical approach to achieving higher transaction throughput. All other approaches discussed till now scale the blockchain at layer 1, wherein layer 1 refers to the transactions recorded on the actual blockchain ledger. The payment channel operates at layer 2, which is also called off-chain. The concept of a payment channel is parallel to the idea of cash. In a regular centralized currency, all transactions need not be performed through the bank, as customers are allowed to take out cash, and using this cash, the customer is able to perform unlimited transactions with someone else owning the cash of the same currency. Just like how transactions of this cash would not be affected by the bank's server limitations, off-chain transactions done via a payment channel would not be affected by the transaction throughput limit of layer 1 blockchain.

FIG. 8 depicts an overview of the payment channel. A funding transaction 802, also known as the channel opening transaction, is the initial on-chain transaction that establishes a payment channel between two parties on the blockchain. This transaction involves locking a certain amount of tokens in a multi-signature address or a smart contract. Off-chain transactions 804 are transactions that occur within the payment channel and are not immediately recorded on the public blockchain. Instead, they are exchanged and updated off-chain between the channel participants. These transactions can include transfers of cryptocurrency or digital assets between the channel participants. A withdrawal transaction 806, also referred to as a channel closing transaction, is the final on-chain transaction that settles the state of the payment channel and moves the funds back to the participants' on-chain wallets. It represents the net result of all off-chain transactions that occurred within the channel.

### Lightning Network:

Lightning Network is the first attempt at a payment channel in blockchain based cryptocurrency. As discussed previously, it simulates cash withdrawal and deposit, but on the blockchain. Lightning Network is a payment channel implementation on the Bitcoin blockchain. Formation of the payment channel requires only one layer 1 transaction, which is called a Funding Transaction. This transaction mentions how many tokens both participants are willing to fund in the channel and how it is distributed among these two participants. Once this funding transaction gets on the chain, these two participants are allowed to make off-chain transactions within the limits of the balance mentioned in the funding transaction sent to the blockchain. This is done by sending balance commitments to each other. A commitment is said to be valid only if it is signed by both participants and it is the latest commitment shared between these two participants. Since these off-chain transactions are not logged onto the blockchain there is no way any node in the bitcoin network could tell if the given commitment is the latest or not. So, the protocol of Lightning Network ensures this using RSMC (Revocable Sequence Maturity Contract). This contract allows one or both participants to withdraw their money from the funding transaction while ensuring no one cheats on the other party. Lightning Network's protocol for payment channels enforces participants to share private keys of old commitments after a new commitment is created. This way, if one cheats with an older commitment, RSMC allows the victim party to take all the money using the secret key of the old commitment. The publisher of a withdrawal transaction is identified by the order of digital signatures done on the commitment.

A single payment channel would allow only these two participants to perform transactions faster. If a participant wants to make transactions via a payment channel with someone else, it would be not practical to open a payment channel for each and every one on the network. To deal with this, Lightning Network utilizes HTLC (Hash Time-Locked Contract) to make a safe payment between participants who are not directly connected via a payment channel but have a path to reach other via multiple payment channels. FIG. 9 depicts an example of a lightning network. The lightning network is a two-way payment channel between users, which enables them to conduct transactions, which would typically occur on the blockchain, off the blockchain, for example, as shown in FIG. 9, between A and B, B and G, D and E, and so on.

### Raiden Network:

Raiden Network is an Ethereum version of the lightning network, wherein the core concepts are pretty much similar to the lightning network. Since Raiden can utilize the Turing complete smart contract functionality of the Ethereum blockchain platform, the formation of a payment channel is quite simpler here. The smart contract holding the balance details of two participants maintains a counter variable initialized to zero. The off-chain transaction here is referred to as Balance Proofs. Each new balance proof generated must increment the counter. Hence, any user deciding to leave the channel or withdraw their tokens can present the latest balance proof to the smart contract. If a partner cheats and puts old balance proof, the other partner can simply present a balance proof with a higher counter, which will then be accepted by the smart contract and tokens will be distributed based on the latest balance proof received.

FIG. 10 depicts the life cycle of the Raiden Payment Channel. A single payment channel would allow transactions between only two involved participants. Like a lightning network, the Raiden network uses similar hash time-locked transactions to perform mediated transfers. During a mediated transfer, involved intermediate accounts would transfer the amount upon a condition of revealing the pre-image related to a certain hash. This pre-image is a secret that is initially only known to the original sender and is not revealed until the final receiver gets the hash time-locked transaction. Once the secret is revealed, the hash time-locked transfer can be enforced on the chain using the secret. FIG. 11 depicts the process of performing a mediated transfer in a Raiden network.

### Cross Chain Bridges:

Cross chain bridges allow interoperability between different blockchain networks by enabling the transfer of assets between them. Different blockchain networks may have unique tokens and features and different protocols specific to their network. For these reasons, different users might choose to have tokens in the blockchain of their choice, which can cause two people wanting to perform a trade, unable to do so. This situation demands a bridge functionality that can allow such cross-chain transfers.

Wrapped Bitcoin (wBTC) is one such cross-chain bridge that allows the transfer of BTC tokens onto the Ethereum blockchain as wBTC tokens in a smart contract. Similarly, wBTC can be converted back to the original BTC token. This transfer is done with the help of a custodian. This custodian has the authority to mint wBTC tokens on the smart contract. BTC owner who wants to get his tokens on the Ethereum blockchain as wBTC has to first send his BTC to the custodian who later mints the wBTC and sends it to the original BTC owner's account address in the Ethereum blockchain for use. Since this transfer relies on a central custodian, this approach is not considered as secure as standard token transfer within a blockchain network.

RenBTC is another example of a cross-chain bridge. This allows a similar conversion from BTC token to RenBTC token on the Ethereum blockchain and the conversion from RenBTC token to original BTC token on the Bitcoin blockchain. The major difference of RenBTC and WBTC is that rather than centralizing custody of transferred BTC, it is decentralized. RenBTC protocol utilizes Shamir's Secret Sharing and Secure Multiparty Computation to achieve this.

BTC Relay protocol allows the verification of Bitcoin transactions on the Ethereum network. It is a decentralized smart contract system built on Ethereum that enables Ethereum smart contracts to securely verify Bitcoin transactions without the need for a trusted third party. The BTC Relay achieves this with the help of relay nodes that sends new block headers to the smart contract. These headers can be utilized to verify any Bitcoin transactions within the BTC Relay smart contract.

Cross-chain transfers in a Lightning Network enables the existing payment channel network of bitcoin to connect with a similar payment channel network of any other blockchain. To enable this cross-chain interoperability, the Lightning Network relies on a participant who holds funds in both blockchain networks and is part of the payment channel network of both. This participant acts as a relay, transferring funds from one payment channel network to the other, essentially creating a bridge between the two networks. This mechanism enables cross-chain transfers between different payment channel networks without building any cross-chain payment channel. One caveat that this strategy introduces is that the common participant has to distribute their funds across two channels. Cross-chain payment channels can potentially eliminate the need for such distribution to enable higher liquidity of funds in the payment channel network.

XClaim is presented as an alternative for Atomic Cross-Chain Swaps, which enables cross-chain transfers between a sender and receiver by creating a smart contract that stores and maintains the headers of the blockchain where the sender resides. Tokens are then essentially burnt on the sender's blockchain, and new tokens are generated on the receiver's blockchain, where the value of these new tokens is validated by the verified proof of burning using only their block headers. Such validation strategy is also used in cross-shard transactions in blockchain sharding systems. XClaim claims that its methodology can be extended to enable cross-chain payment channels, but it does not provide any concrete protocol to achieve that.

Though such existing cross-chain bridges allow the transfer of tokens between different blockchain networks, they sometimes rely on a centralized authority to do so, which is not a desirable property in terms of security. Even if other cross-chain bridges achieve this token transfer in a decentralized manner, none of the existing cross-chain transfer techniques provides a general-purpose cross-chain payment channel protocol that allows the transfer of native tokens.

Hence, there is a need in the art for solutions which will overcome the above-mentioned drawback(s), among others.

### Objects

The principal object of embodiments herein is to disclose a formation and termination mechanism for a general-purpose Cross-Chain Payment Channel (CCPC) protocol, wherein the CCPC protocol represents a solution for executing fund transfers between two accounts residing in different blockchains off-chain by building a payment channel between the two accounts and breaking down the funding and withdrawal transactions into multiple transactions to allow for the safe formation and termination of a payment channel between the two blockchains.

Another object of embodiments herein is to disclose a formation and termination mechanism for a general-purpose Cross-Shard Payment Channel (CSPC) protocol in a sharding system to perform cross-shard transactions, wherein a payment channel is built between accounts from two shards, which would dramatically reduce the number of actual cross-shard transactions recorded at the layer 1 blockchain, resulting in lower latency of cross-shard transactions, as compared to existing sharding schemes.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a blockchain and state machine, wherein the current state of the system is represented with Sₖ, according to existing arts;

FIG. 2 illustrates forking in a blockchain, according to existing arts;

FIG. 3 depicts the concept of blockchain sharding, according to existing arts;

FIG. 4 depicts the Atomix protocol, according to existing arts;

FIGS. 5A and 5B depict a comparison of the standard sharding scheme and mitosis, according to existing arts;

FIG. 6 depicts a visualization of the account segmentation technique, according to existing arts;

FIGS. 7A and 7B depict the results of BrokerChain with 64 shards and 32 shards respectively, according to existing arts;

FIG. 8 depicts an overview of the payment channel, according to existing arts;

FIG. 9 depicts an example of a lightning network, according to existing arts;

FIG. 10 depicts the life cycle of the Raiden Payment Channel, according to existing arts;

FIG. 11 depicts the process of performing a mediated transfer in a Raiden network, according to existing arts;

FIG. 12 depicts two shards forming a payment channel together, according to embodiments as disclosed herein;

FIG. 13 illustrates the funding phase, according to the embodiments herein;

FIG. 14 depicts a scenario, wherein discard partial funding is performed, according to embodiments as disclosed herein;

FIG. 15 depicts an example of the body of a balance proof, according to embodiments as disclosed herein;

FIG. 16 depicts an example scenario, wherein there is only one participant, according to embodiments as disclosed herein;

FIG. 17 depicts an example scenario, wherein one participant tries to maliciously close the channel, according to embodiments as disclosed herein;

FIG. 18 depicts an example scenario, wherein both participants participate and cooperate to withdraw from the channel, according to embodiments as disclosed herein;

FIG. 19 depicts an example scenario, wherein both participants initiate, but one of the proposal times out, according to embodiments as disclosed herein;

FIG. 20 depicts the block header setup in both blockchains, according to embodiments as disclosed herein;

FIG. 21 depicts the cross chain payment channel state, according to embodiments as disclosed herein;

FIG. 22 illustrates blockchain system comprising hardware and software components for forming and terminating a payment channel between two distinct ledgers, according to embodiments as disclosed herein;

FIG. 23 illustrates the method steps involved in the formation and termination of payment channel between two distinct ledgers, according to embodiments as disclosed herein;

FIG. 24 depicts a setup for GoQuorum nodes, according to embodiments as disclosed herein;

FIG. 25 depicts the L2CS architecture, according to embodiments as disclosed herein; and

FIG. 26 depicts the L2CS Channel Formation Workflow, according to embodiments as disclosed herein.

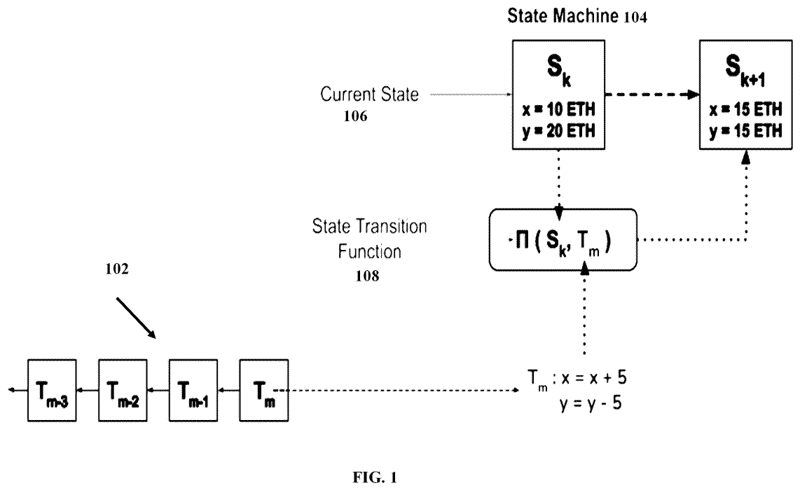

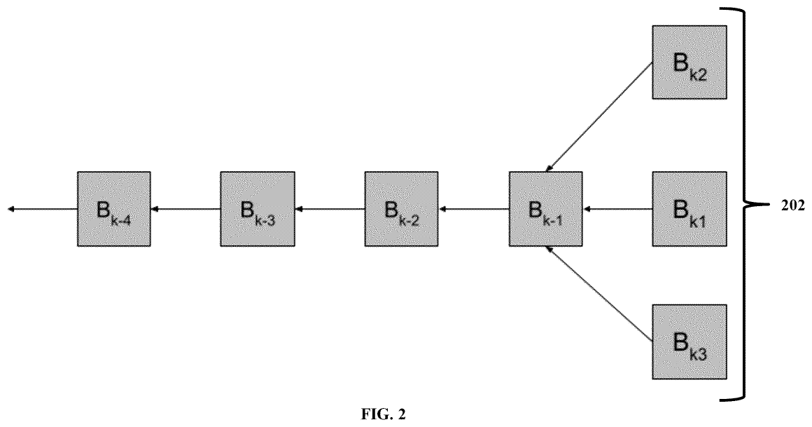

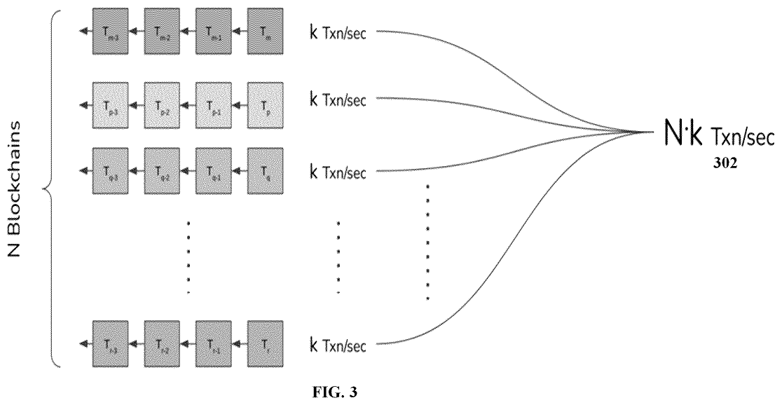

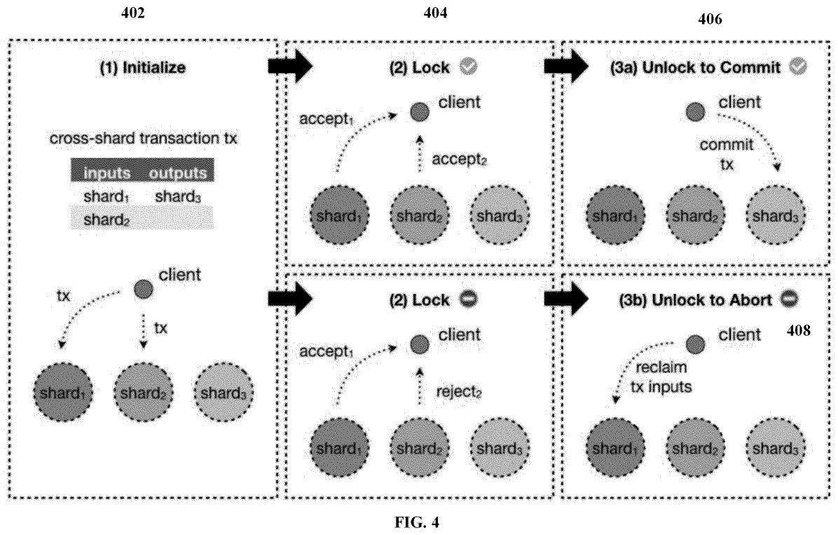

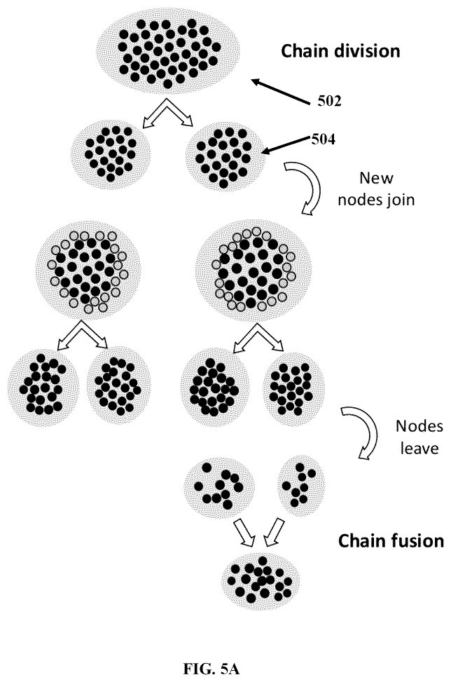

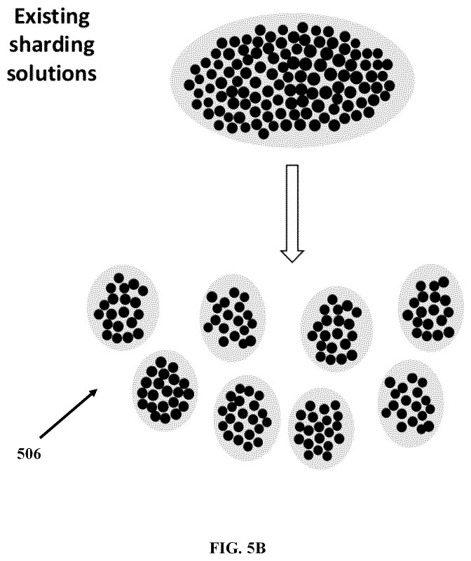

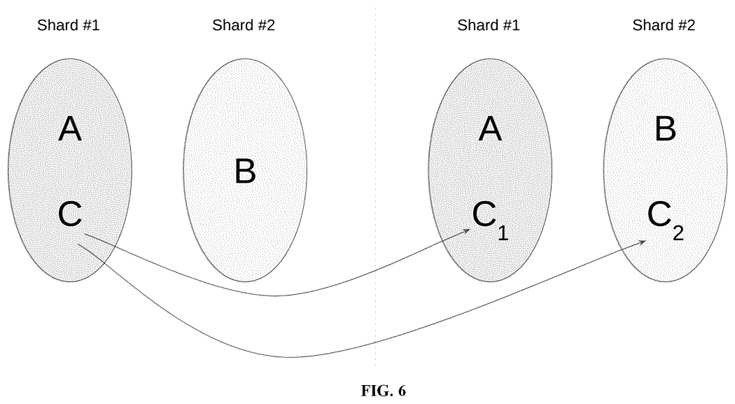

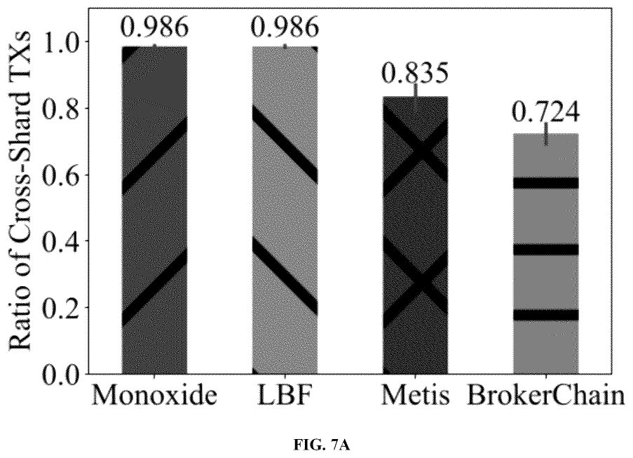

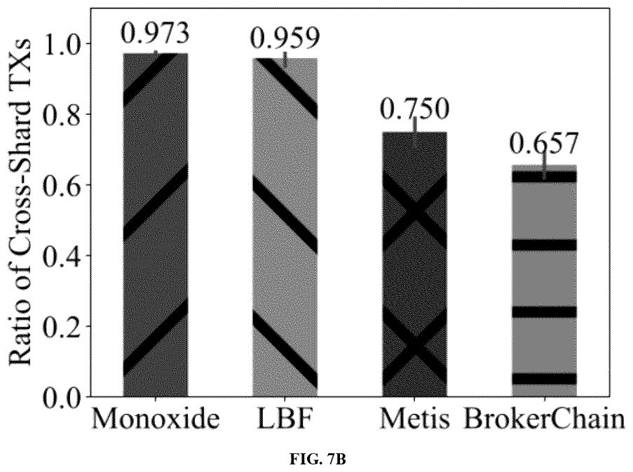

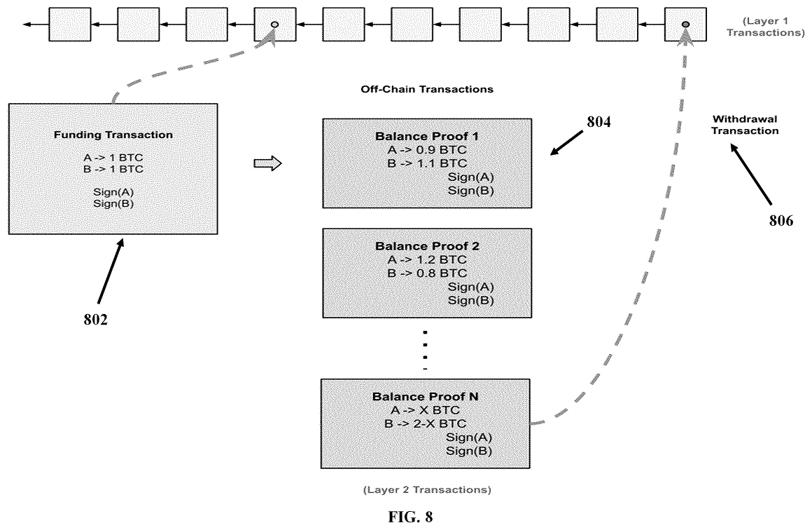

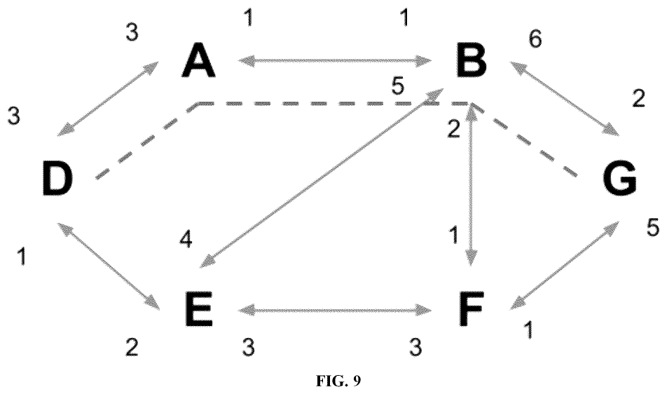

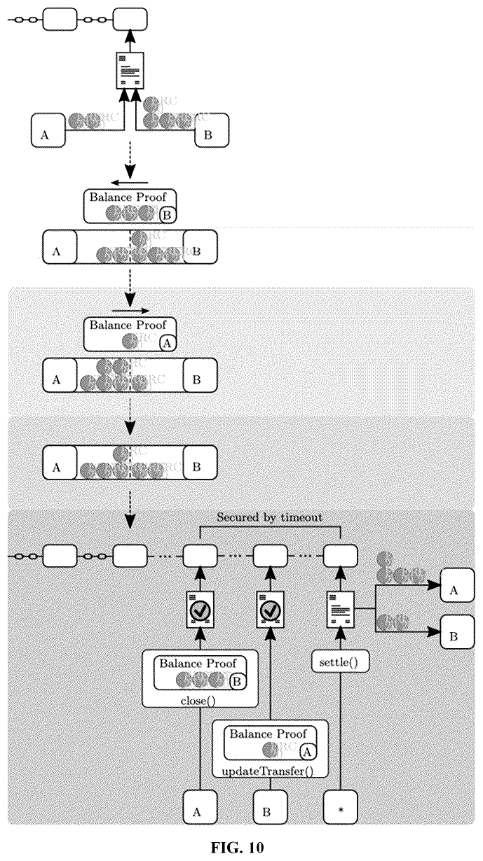

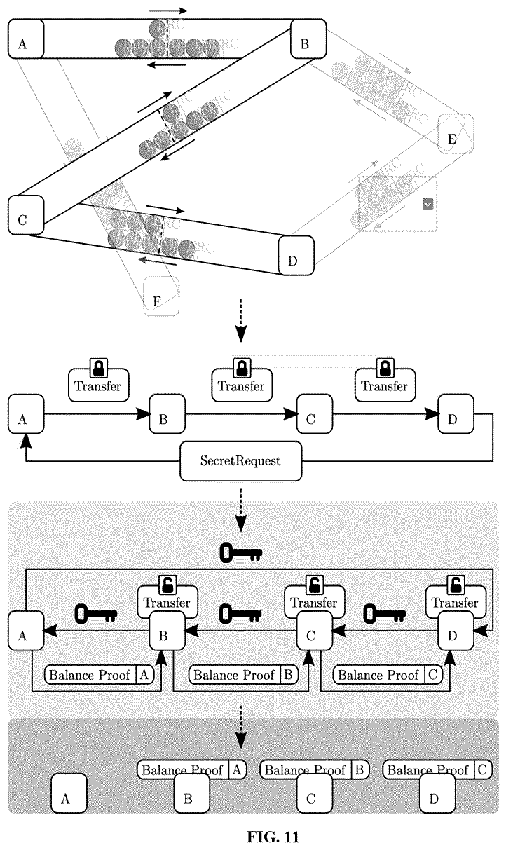

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

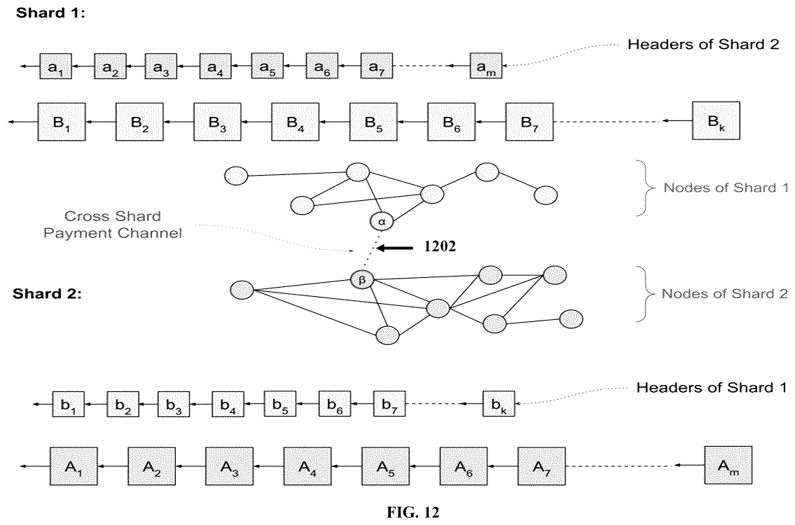

Embodiments herein achieve a formation and termination mechanism for a Cross Shard Payment Channel protocol. Referring now to the drawings, and more particularly to FIGS. 12 through X, where similar reference characters denote corresponding features consistently throughout the figures, there are shown embodiments.

Embodiments herein tackle cross-shard transaction latency issues by leveraging concepts from the payment channel, wherein cross-shard transactions are optimized in a sharded blockchain system to have a payment channel between shards.

Embodiments herein disclose a formation and termination mechanism for a general-purpose Cross-Chain Payment Channel (CCPC) protocol, wherein the CCPC protocol represents a solution for executing fund transfers between two accounts residing in different blockchains off-chain by building a payment channel between the two accounts and breaking down the funding and withdrawal transactions into multiple transactions to allow for the safe formation and termination of a payment channel between the two blockchains. Embodiments herein disclose a formation and termination mechanism for a general-purpose Cross-Shard Payment Channel (CSPC) protocol in a sharding system to perform cross-shard transactions, wherein a payment channel is built between accounts from two shards, which would dramatically reduce the number of actual cross-shard transactions recorded at the layer 1 blockchain, resulting in lower latency of cross-shard transactions, as compared to the existing sharding schemes.

### Cross Shard Payment Channel (CSPC):

FIG. 12 depicts an overview of the sharding system, according to the embodiments herein. The sharding system comprises an arbitrary number of shards, but embodiments herein have been explained using interactions between two shards. It may be obvious to a person skilled in the art that the embodiments herein may be extended to interactions between an arbitrary number of shards. Each shard has a common blockchain with a disjoint set of accounts that are solely maintained by that shard. Each shard also has its own network of nodes that are involved in the consensus mechanism for adding a new block to the blockchain. These nodes are referred to as “consensus nodes” and can use any consensus protocol chosen by the shard, such as, but not limited to, Proof of Work, Proof of Stake, a combination of Proof of Work and Proof of Stake, Proof of Space, Proof of Time Elapsed, Algorand, RAFT, PBFT, and so on. The CSPC protocol is independent of the consensus mechanism being used.

In addition to their own shard's blockchain, each node in a shard listens for and maintains headers of all other shards' blockchains. Since headers are lightweight, this does not impose a significant resource requirement on the node. For instance, as shown in FIG. 12, there are two shards, Shard 1 and Shard 2. Shard 1 and Shard 2 are a part of a single blockchain, and blocks B1, B2, . . . , Bk are a part of Shard 1 and the blocks A1, A2, . . . , Am belong to Shard 2. The headers of Shard 2, i.e., a1, a2, . . . , am are maintained by Shard 1 and the headers of Shard 1 b1, b2, . . . , bk are maintained by Shard 2. Embodiments herein assume that once a block is added to the chain, it remains in the blockchain forever, hence transactions residing inside such blocks are considered committed. The finality of each new block is guaranteed, using a consensus protocol such as, but not limited to, Proof-of-Authority, or through other consensus protocols such as Proof-of-Work, where block finality can be assumed with high probability after achieving a certain number of confirmations.

For two account owners from different shards to participate in a cross-shard payment channel, they must be full nodes of both shards. Full nodes are nodes that maintain the full blockchain but may not necessarily participate in consensus.

FIG. 12 depicts an account a from Shard 1 and an account 3 from Shard 2 forming a payment channel 1202 together. In order to establish or form a payment channel between two shards in a sharded blockchain system, a critical step is to set up funding transaction. In order to establish a payment channel between two shards in a sharded blockchain system, a critical step is setting up a funding transaction. However, this presents a unique challenge, as the state of such a transaction needs to be synchronized between both shards. Simply creating a single funding transaction in each shard independently would not suffice, as one shard would not be aware of the balance state of the other shard's account. Furthermore, a regular cross-shard transaction that operates in the form of a fund transfer from an input account in one shard to an output account in another shard would not be sufficient. Instead, the cross-shard payment channel must facilitate two-way fund transfers with specific rules.

The funding phase comprises a proposed funding transaction and a confirmed funding transaction. To initiate a cross-shard payment channel (CSPC), both participants must first agree on the channel's balance off-chain, after which they will broadcast a “Propose Funding” transaction in their respective shards. This transaction should contain the balance of each participant and the necessary digital signatures, serving as the first balance proof of the payment channel. In α's shard, the balance proof in the ‘Propose Funding’ transaction must be signed by β or both participants and similarly, in β's shard, the balance proof in the funding transaction must be signed by α or both participants. This transaction locks the mentioned funds for a minimum time period ‘T’, which can be defined in terms of the number of blocks.

However, the proposed funding transaction alone is insufficient to establish a payment channel, as the consensus nodes in each shard cannot trust the balance of the participant of the CSPC from the other shard. To gain this trust, both participants must present proof to their respective shards showing that their partner's balance is locked in their funding transaction as well. This proof must be provided before the timeout expires and is shown in the “Confirm Funding” transaction.

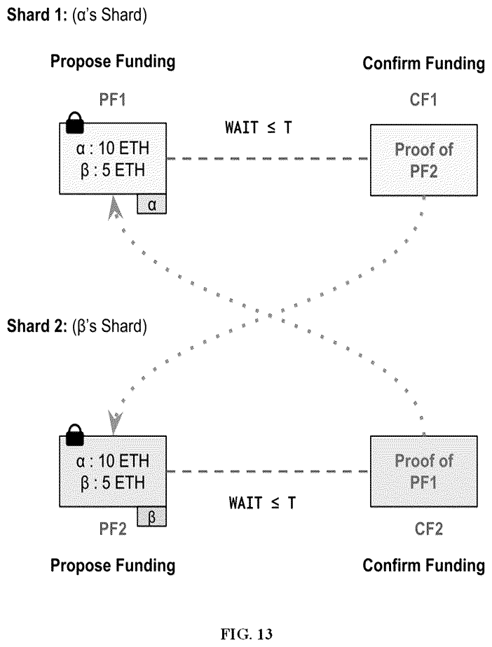

FIG. 13 illustrates the funding phase, according to the embodiments herein. As depicted in FIG. 13, both participants must either communicate the proof to each other or obtain it themselves from their partner's shard and send a ‘Confirm Funding’ transaction to their respective shard with a valid proof. Once a valid ‘Confirm Funding’ transaction is committed on each shard, the formation of CSPC is complete. To prove the existence of a transaction in a blockchain, a Merkle Proof can be used, which can be verified using the root hash of the block containing the transaction. As each node maintains headers of other shards, it is possible to validate whether a transaction belongs to the blockchain of a particular shard, even without having access to the full blockchain. This is achieved by providing the transaction along with its Merkle Proof, which allows anyone to validate the transaction's authenticity.

After the Propose Funding transaction is broadcasted and confirmed on the blockchain, a waiting period T begins for the ‘Confirm Funding’ transaction to be submitted. If a participant fails to show valid proof with the ‘Confirm Funding’ transaction within the waiting period T, the ‘Propose Funding’ transaction is discarded, and the payment channel is not established. However, if both participants successfully provide valid proofs with their ‘Confirm Funding’ transactions before the waiting period T ends, the payment channel is successfully formed.

In the event that one participant fails to submit a ‘Confirm Funding’ transaction, while the other participants successfully lock their tokens in the payment channel, the participant who is unable to lock their tokens may lose them permanently. To avoid this scenario, both participants should broadcast their own Merkle proof in the form of a ‘Confirm Funding’ transaction to their partner's shard each time a payment channel is formed.

However, if a situation arises where the funding transaction is confirmed in one shard, but the ‘Propose Funding’ transaction times out in the other, the smart contract will allow the release of a “FUNDING DISCARDED” event. Any participant can request the smart contract to generate this event.

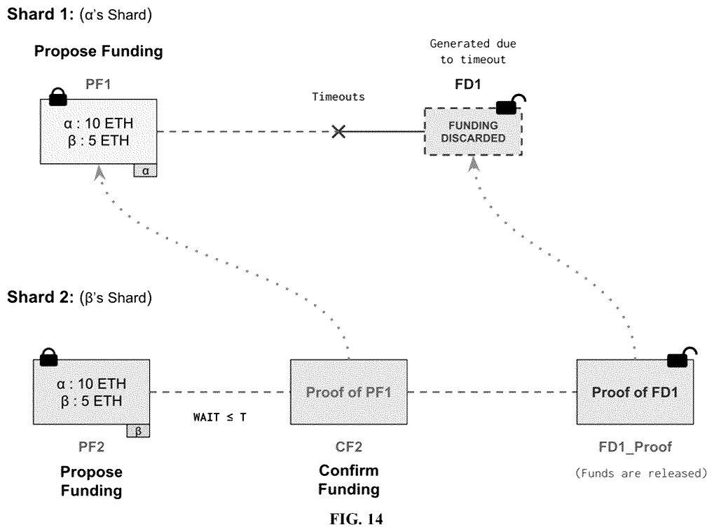

FIG. 14 depicts a scenario, wherein discard partial funding is performed. As depicted in FIG. 14, if the account β realizes that although he has confirmed the funding in his shard, he cannot proceed further as the funding proposal has reached the timeout in a's shard. To discard the formation of the payment channel in β's shard, β can request the “FUNDING DISCARDED” event by calling a dedicated function on the payment channel smart contract in α's shard. This function call would also release the locked funds for α. After the event is generated, β can fetch the Merkle proof and present it in their own shard as an FD1_Proof transaction (as shown in FIG. 14). This would release the locked funds for β. By implementing these measures, participants can ensure that the formation of the payment channel is successful, and that any potential loss of funds is avoided.

Establishing a successful Cross-Shard Payment Channel allows participants to perform off-chain transactions by sending updated balance proofs to each other.

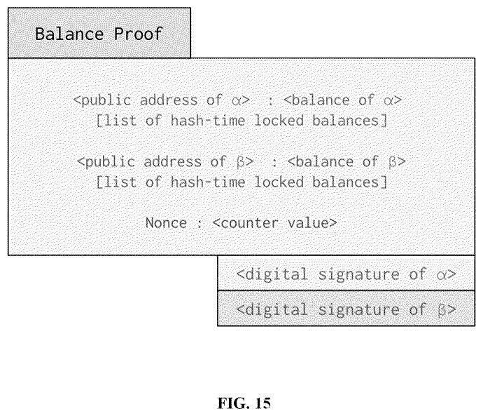

FIG. 15 depicts an example of the body of a balance proof, according to the embodiments herein. Each balance proof must be signed by both participants and contain an updated balance of both participants within the total balance of the payment channel. Additionally, each balance proof must include a counter value that increments for each new balance proof generated. It is crucial to note that the counter of any signed or partially signed balance proof by a participant, once published, should never be used again to prevent replay attacks. This counter value will be later used in the withdrawal phase to differentiate between old and new balance proofs. To perform off-chain transactions, the sender would sign updated balance proofs and send them to the receiver. After each successful transaction, participants must increment the counter value to create a new balance proof. These balance proofs can be exchanged multiple times without incurring any additional transaction fees. In case of any disputes, either participant can submit the latest signed balance proof to the blockchain to ensure their funds are secured.

According to the embodiments herein, in scenarios, where two users are not directly connected by a payment channel, the users can still transfer funds by utilizing intermediate payment channels. In such cases, participants of mediated transfer would send a hash-locked balance proof, which is considered valid only if presented with a valid secret. This mechanism is commonly known as Hash Time-Locked Contracts (HTLCs). To perform a mediated transfer, the participant initiating the mediated transfer locks a certain amount of funds in a payment channel with an intermediary node and provides a hash-locked balance proof to that node, who in turn does the same with another intermediary node or directly to the recipient node. The recipient can claim the funds by revealing the pre-image of the hash lock within a certain time frame; otherwise, the locked funds will be refunded back to the initiator. These hash-locked balance proofs could be enforced on the cross-shard payment channel with a valid secret, using the withdrawal mechanism discussed in the following section.

One or both participants may decide to leave the channel at any time, so the CSPC protocol should allow for this functionality in a multi-shard system. However, closing the channel and releasing the funds back to the blockchain must be handled carefully to ensure that any partially committed withdrawal does not result in an inconsistent system. Embodiments herein disclose two different possible scenarios for attempting a withdrawal in detail. Case 1 is when only one of the participants proposes the withdrawal; and case 2 is when both the participants propose the withdrawal.

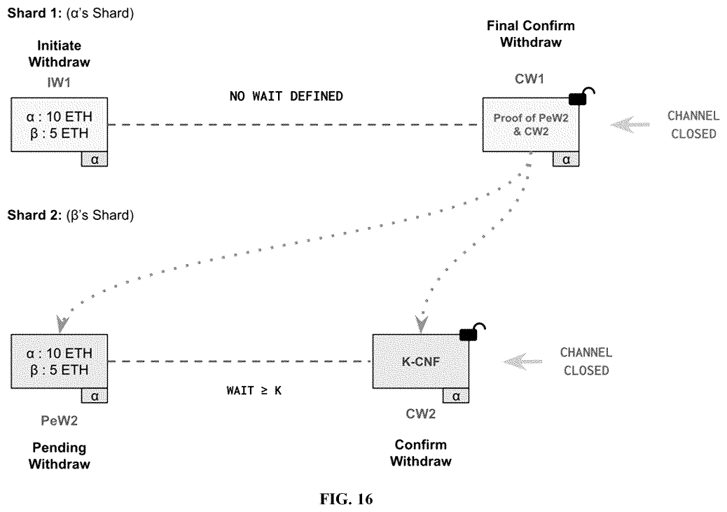

FIG. 16 depicts an example scenario, wherein there is only one participant, according to the embodiments herein. When one of the participants decides to close the channel, they must initiate the withdrawal process with an ‘Initiate Withdraw’ (IW1) transaction. This transaction should include a valid and up-to-date balance proof and must be signed by the proposer. Since the other participant is not active, the first participant must also initiate the same withdrawal process in their partner's shard. In the other shard, the proposal is treated as a ‘Pending Withdraw’ (PeW2), as it is initiated by someone who is not a member of that shard. To confirm the withdrawal in Shard 2, a ‘Confirm Withdraw’ (CW2) transaction must be made after at least K blocks from the PeW2 transaction. This waiting period is enforced to allow the other participant 3, to propose another valid balance proof, if one exists. Once the K-CNF transaction is committed in Shard 2, the funds from the channel are released and the channel is closed.

Now, participant α can release their funds from their own channel by presenting proof that they have waited long enough for R to challenge the withdrawal. This is achieved by submitting a ‘Final Confirm Withdraw’ (CW1) transaction that includes the Merkle proof of PeW2 and CW2. The contract on the blockchain verifies whether the block distance between these two transactions is greater than or equal to K. Once this is confirmed, committing the CW1 transaction releases the funds from the channel and the channel is permanently closed.

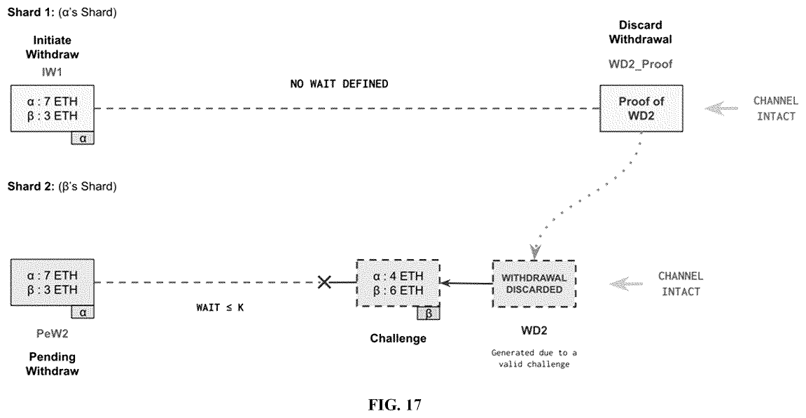

The proposer might try to maliciously close the channel based on some older balance proof. FIG. 17 depicts an example scenario, wherein one participant tries to maliciously close the channel, according to the embodiments herein. In this case, there is a chance that the other participant notices this malicious withdrawal and challenges the ‘Pending Withdrawal’ in its shard with the latest valid balance proof. A valid balance proof, once presented in the challenge transaction, would immediately generate a ‘Withdrawal Discarded’ event, and hence the smart contract handling this would no longer accept any ‘Confirm Withdraw’ transaction and as a result, the malicious proposer would not be able to achieve final confirmation in his shard. Now, the Merkle proof of this ‘Withdrawal Discarded’ transaction can be used as proof of rejection to terminate the indefinite wait for final confirmation in the malicious proposer's shard.

In case 2, where both the participants agree to close the channel cooperatively, they can initiate a ‘Propose Withdraw’ request in their respective shards, using the same balance proof. To achieve a partially completed withdrawal, both participants are required to share the Merkle proof of their proposal with each other. However, this state is not yet confirmed, as there is no guarantee that the other participant has successfully presented the proof of proposal before the timeout. To avoid such inconsistencies, both participants must provide a ‘Final Confirmation’ which includes the Merkle proof of the ‘Partial Confirmation’ from the other participant's shard.

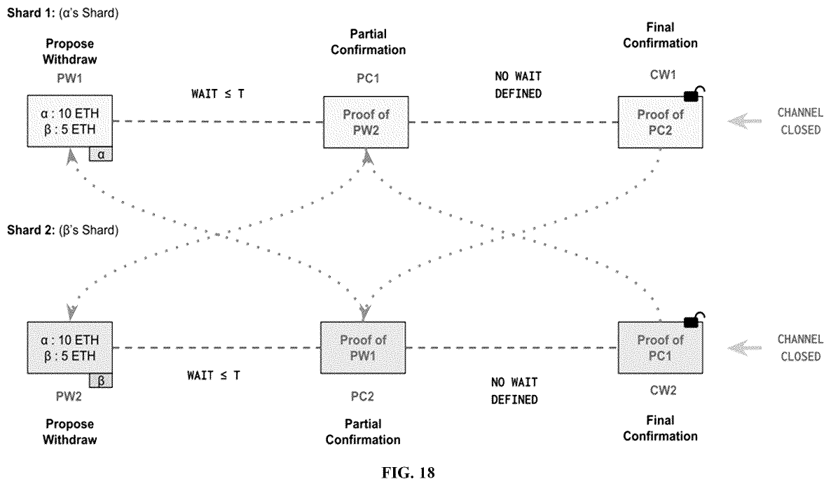

FIG. 18 depicts an example scenario, wherein both participants participate and cooperate to withdraw from the channel, according to the embodiments herein. This approach ensures that both participants have completed the necessary steps to withdraw funds from the payment channel without leaving any partially committed withdrawals, thereby maintaining the integrity of the system.

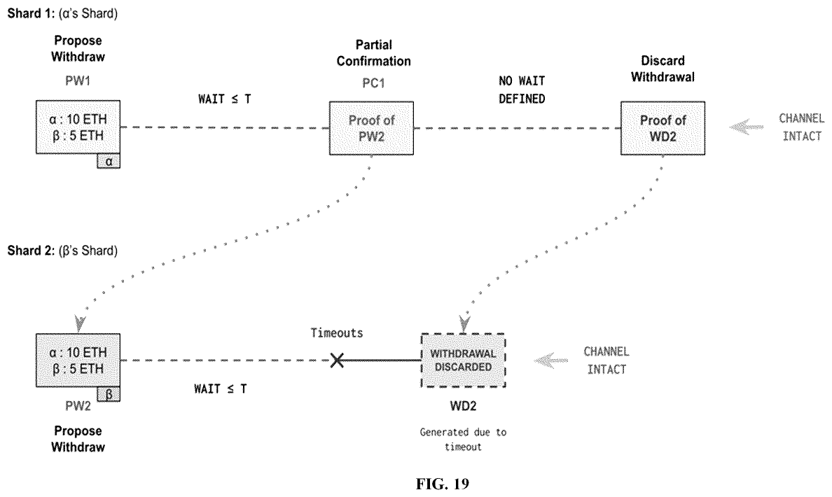

In some cases, a partially completed withdrawal may result in a failed withdrawal, if one of the participants fails to achieve partial confirmation before the timeout. FIG. 19 depicts an example scenario, wherein both participants initiate, but one of the proposal times out, according to the embodiments herein. However, the CSPC protocol is designed to handle such situations to maintain consistency between shards. If a withdrawal is discarded in one shard due to a failed partial confirmation, the smart contract generates a “WITHDRAWAL DISCARDED” event which can be used to discard the withdrawal in the other shard using its corresponding Merkle proof. This ensures that both shards remain consistent even if one of the participants fails to follow the protocol. As there is no waiting time after the Partial Confirmation, participants have the flexibility to perform the relevant actions whenever they choose to do so. Once the partial confirmation is achieved in both shards, any participant can make the ‘Final Confirmation’ on either shard to gain access to the released funds, based on their individual incentives.

Embodiments herein disclose Cross Chain Payment Channel (CCPC) protocol which extends the previously discussed CSPC protocol to support token transfer between two different blockchain networks. CCPC is essentially a cross-chain bridge that can be easily integrated with the existing payment channel network supporting CSPC protocol, to allow a larger payment channel network that can safely transfer tokens off-chain in a trustless environment.

The CCPC protocol outlines a method for creating and closing a payment channel between two accounts located on two distinct and autonomous blockchains. Blockchain systems should support Turing-complete smart contracts which shall later be used to verify proof showing the locking of tokens in the other blockchain. The smart contract handling the CCPC stores block headers of the other blockchain with the help of relay nodes. This strategy resembles the one used in BTC Relay. Block headers of the other chain are maintained on smart contracts from both blockchains.

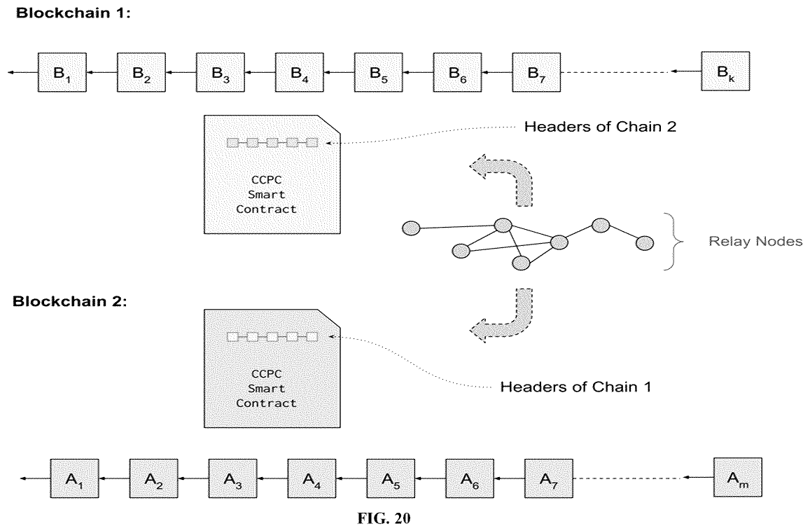

FIG. 20 depicts the block header setup in both blockchains, according to the embodiments herein. Relay Nodes are required to update the headers of the other blockchain in both smart contracts. To make this process autonomous, relayers can be incentivized with a strategy similar to BTC Relay.

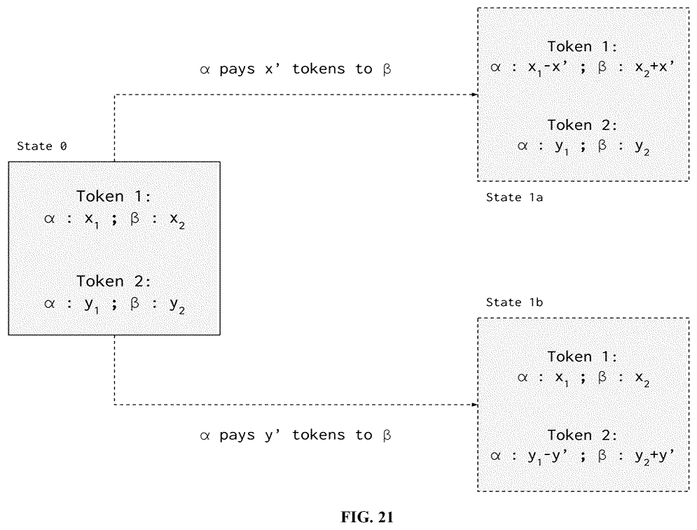

Since the involved blockchains support different tokens, a simple token transfer in a one-to-one ratio would not work as their token value ratio might be uneven. To enable the cross-chain transfer, participants involved in CCPC own an address in each blockchain. Participants initiate funding of this CCPC channel by locking their tokens into the smart contract which maintains a state of their balances in both chains. Funding of the cross chain payment channel proceeds with a state represented in State 0 as shown in FIG. 21.

FIG. 21 depicts the cross chain payment channel state, according to the embodiments herein. As shown in State 0 in FIG. 21, α and β would have both tokens registered in the smart contract for both blockchains. FIG. 21 indicates that α owns x1 tokens in Blockchain 1 and y1 tokens in Blockchain 2, while β owns x2 tokens in Blockchain 1 and y2 tokens in Blockchain 2. In the case where participants own tokens in only their former blockchain, x2 and y1 can both be set to 0.

Since both participants can own tokens in both blockchains, the token exchange becomes easier. After the funding phase of the channel is complete, if α wants to make a payment of x′ tokens of Blockchain 1 to β, α can send a signed balance proof to β containing a state as shown in State 1a in FIG. 21. Alternatively, α can calculate the exchange value of x₁ tokens in Blockchain 2 using an exchange rate R. Assuming y′=R*x′, α can send a balance proof containing State 1b as shown in FIG. 21. In a more general case, α can send x″ tokens of Blockchain 1 and y″ tokens of Blockchain 2 to β, where x″+y″/R=x′. Except for the state, the procedure for off-chain transactions with CCPC would be the same as discussed previously.

Withdrawal process in the CCPC protocol is implemented similar to the CSPC protocol. However, there are variations in the specific state representation involved. If participants decide to perform a withdrawal at State 0 as shown in FIG. 21, α would get x₁ tokens unlocked in Blockchain 1 and y₁ tokens in Blockchain 2, while β would get x₂ tokens unlocked in Blockchain 1 and y₂ tokens in Blockchain 2.

In another embodiment herein, in situations where participants prefer not to hold an account in a different blockchain, the protocol should cater to their needs. For instance, participant α may only want to possess tokens in Blockchain 1 while participant β may prefer to hold tokens solely in Blockchain 2. To address this issue, the CCPC protocol can be modified to include a unique ‘Cross Token’, denoted by a new token symbol such as ‘cTokenName’ and referred to as “Cross TokenName”. This token would represent a token from the other blockchain, allowing participants to hold and transact using it without actually maintaining an account in the foreign blockchain. For example, as shown in FIG. 20, a cross-chain channel between Blockchain 1 which supports Token 1, and Blockchain 2 which supports Token 2, the cross-chain channel smart contract on Blockchain 1 can generate a new cToken2 (Cross Token 2) token and the corresponding contract on Blockchain 2 can have a new cToken1 (Cross Token 1) token, upon transfer. Using this methodology, if participants decide to perform a withdrawal at State 0 as shown in FIG. 21, a would get x₁ tokens unlocked in Blockchain 1 and would receive y₁ cToken2 in the same blockchain.

It is assumed that participants in cross-chain payment channels must operate as full nodes on both blockchains, which can significantly strain their computational resources. However, there is a more efficient approach that can reduce resource usage without compromising security. Participants can choose to operate as a full node only on their native blockchain while remaining a light node on their partner's blockchain. This optimized mode enables participants to conserve their resources until their partner exhibits malicious behavior. If a participant detects malicious behavior on their blockchain from their partner, they can switch to become a full node on the other blockchain and continue with the protocol. The wait time can be adjusted to ensure that victims using this optimized mode have ample time to make the switch. By adopting this optimized mode, participants in cross-chain payment channels can maintain security while reducing the burden on their computational resources.

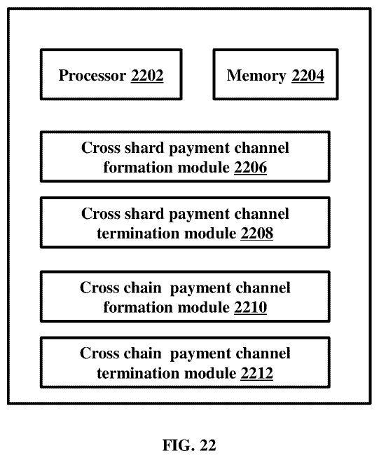

FIG. 22 illustrates blockchain system 2200 comprising hardware and software components for forming and terminating a payment channel between two distinct ledgers, according to the embodiments herein. The distinct ledgers can be two shards from a single blockchain, or two different blockchain networks. The blockchain system (2200) comprises a processor 2202, a memory 2204 coupled to the processor 2202, a cross shard payment channel formation module 2206, a cross shard payment channel termination module 2208, a cross chain payment channel formation module 2210, and a cross chain payment channel termination module 2212. The processor (2202) is configured to execute instructions stored in the memory (2204) and to perform various method steps according to the embodiments herein.

According to the embodiments herein, the cross-shard payment channel formation module 2206 initiates a proposed funding transaction between a first participant of a first shard and a second participant of a second shard, wherein initiating the proposed funding transaction comprises locking specified number of tokens, and wherein the specified number of tokens includes number of tokens proposed by the two participants. The cross-shard payment channel formation module 2206 exchanges balance proofs to validate the locked tokens. The cross-shard payment channel formation module 2206 confirms the proposed funding transaction between the first participant and the second participant by securing the locked tokens for a defined time period. The cross-shard payment channel formation module 2206 communicates formation of CSPC transaction on each of the first shard and the second shard, indicating the successful formation of the CSPC. The cross shard payment channel termination module 2208 enables initiation of a withdrawal request by one of the first participant and the second participant, indicating unlocking of a specified amount of tokens. The cross shard payment channel termination module 2208 enables sharing and validation of Merkle Proofs for withdrawal transactions to prove the authenticity and legitimacy of the withdrawal request. The cross shard payment channel termination module 2208 enables release of the locked tokens based on validated proofs, following one of a predefined block distance and challenge period. The cross shard payment channel termination module 2208 allows the first and the second participant to challenge malicious withdrawal attempts, using Merkle Proofs to demonstrate proof of rejection.

According to the embodiments herein, the cross chain payment channel formation module 2210 initiates one or more proposed funding transactions on the first blockchain network and the second blockchain network involving a plurality of participants, locking specified amounts of tokens. The cross chain payment channel formation module 2210 enables exchange of one or more balance proofs to validate the locked tokens on the first blockchain network and the second blockchain network. The cross chain payment channel formation module 2210 confirms the proposed one or more proposed funding transactions in the first blockchain network and the second blockchain network, securing the locked funds for a predefined time period. The cross chain payment channel formation module 2210 enables communication of a “CCPC Formed” transaction on each of the first and the second blockchain networks, indicating the successful formation of the CCPC. The cross chain payment channel termination module 2212 enables initiation of a withdrawal request by a participant on both the first and second blockchain networks, for unlocking the specified amounts of tokens. The cross chain payment channel termination module 2212 enables sharing and validation of Merkle Proofs for withdrawal transactions to prove the authenticity and legitimacy of the withdrawal request on both the first and second blockchain networks. Blockchain systems should support Turing-complete smart contracts which shall later be used to verify proof showing the locking of tokens in the other blockchain. The smart contract handling the CCPC stores block headers of the other blockchain with the help of relay nodes. Block headers of the other chain are maintained on smart contracts from both blockchains. In cross chain payment channel protocol, the relay node system sends across the merkle root information from one chain to the other. The cross chain payment channel termination module 2212 enables release of the locked tokens based on validated proofs, following one of a predefined block distance, or challenge period. The cross chain payment channel termination module 2212 allows the one or more participants to challenge malicious or fraudulent withdrawal attempts, using Merkle Proofs to demonstrate proof of rejection.

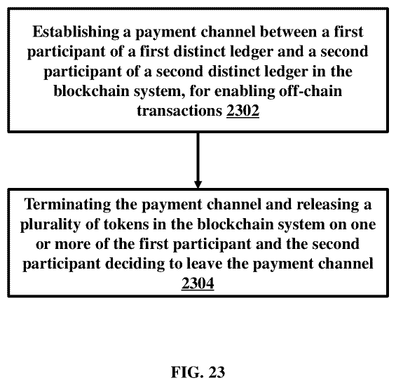

FIG. 23 illustrates the method steps involved in the formation and termination of payment channel between two distinct ledgers, according to the embodiments herein. At step 2302, the method comprises establishing a payment channel between a first participant of a first distinct ledger and a second participant of a second distinct ledger in the blockchain system, for enabling off-chain transactions. At step 2304, the method comprises terminating the payment channel and releasing a plurality of tokens in the blockchain system on one or more of the first participant and the second participant deciding to leave the payment channel.

### Implementation:

The Cross-Shard Payment Channel protocol is implemented by adding an L2CS (Layer 2 Cross-Shard) API layer on top of the existing Web3 Library which interacts with Ethereum nodes. Since there does not exist any open source implementation available of standard sharding protocol, the L2CS API is designed to emulate sharding on existing Go-Ethereum like implementation.

### Nodes Setup:

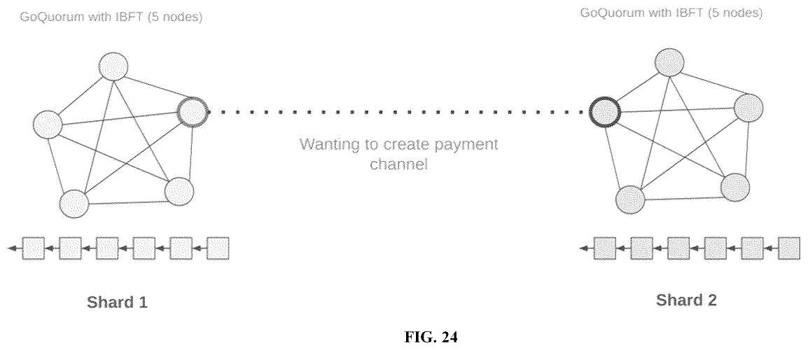

Two different independent networks of Go-Quorum nodes are running that are maintaining two different blockchains. Both networks of nodes are running on the same physical machine. Each network has a total of 5 nodes. Due to its block finality property, the consensus mechanism used here is IBFT (Istanbul Byzantine Fault Tolerant), which is a modified PBFT algorithm. Each node owns an account on its respective blockchain, and each account is sufficiently funded right from the genesis. Each node exposes its own API via an HTTP server which is consumed by Web3 Library. This setup is illustrated in FIG. 24 (which depicts a setup for GoQuorum nodes).

### L2CS Architecture:

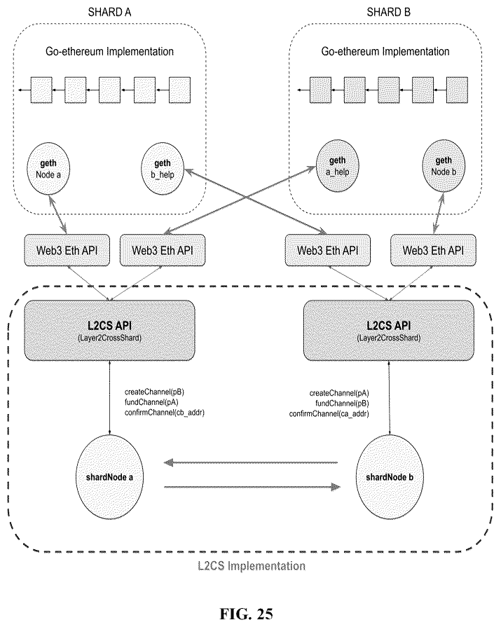

This implementation assumes that both nodes involved in the payment channel have access to both shards. Hence, each instance of L2CS stays connected to two nodes. One node is the self-node while the other node is a node from the other shard to look at the status of Cross Shard Channel Contract in the other shard. The L2CS API is written in Node.js and is implemented as REST API. L2CS API provides functions such as createChannel( ), fundChanel( ), confirmChannel( ), and so on. Now, the actual shard node is supposed to communicate with the L2CS API directly rather than using Web3 to interact with the geth node. Hence, the L2CS API in a way becomes a part of the protocol. For any two nodes interested in forming a payment channel, each would have to communicate using an instance of L2CS API. This architecture is illustrated in FIG. 25 (which depicts the L2CS architecture).

### Sharding Emulation:

There is no notion of sharding in the existing implementation of Go-Quorum/Go-Ethereum. Hence, for the experimental implementation, L2CS emulates sharding. In the actual implementation of sharding the geth nodes would need to store headers of other shards in order to verify any transaction using only Merkle proof, so that tokens from other shards can be added to the current shard. This notion is discussed in the sharding Model section in chapter 3. Since there is no such provision in existing Ethereum implementation, this is emulated by assuming the existence of an account that has infinite tokens, which can only be used by the L2CS program to represent funds from other shards.

### L2CS API:

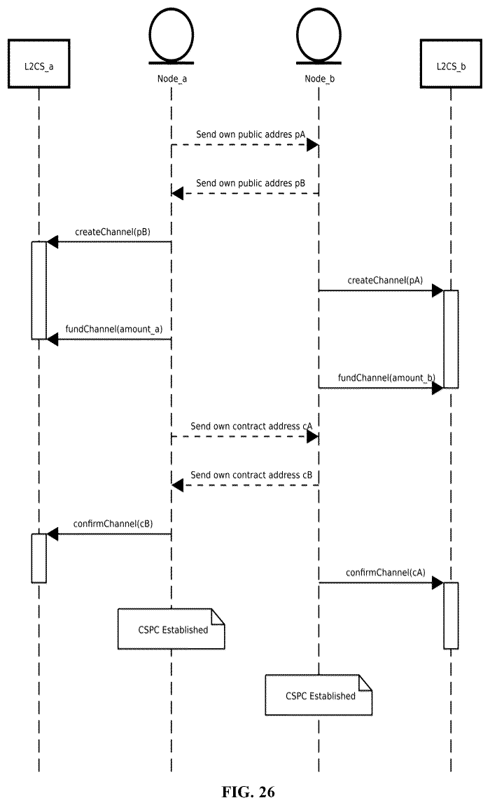

This section gives details about each API endpoint that a shard node would need to interact with L2CS. Three major endpoints are discussed in their dedicated sections below. Minor endpoints for requesting trivial details about self-node are as discussed in the miscellaneous section. The sequence of calling these endpoints is as shown in FIG. 26 (which depicts the L2CS Channel Formation Workflow).

### Create Channel:

createChannel(public_address_of_partner_account)

Participants interested in forming the payment channel shares their account's public address with each other. As one receives the public address of their partner, they can make a createChannel( ) call to the L2CS API. Upon receiving this request, L2CS internally compiles a Cross Shard Channel solidity contract using the solc library. After the compilation, it deploys the contract which has a 0 balance initialized for both partners.

### Fund Channel:

fundChannel(amount_of_tokens_to_fund)

Once the cross-shard channel contract is deployed on the blockchain, each participant can put their funds by making a payment to that contract by calling the fundChannel( ) function of the smart contract. The L2CS API simplifies this by exposing this endpoint named the same as fundChannel( ), where the node can simply pass the argument as the desired amount they want to lock in the channel, and the rest is taken care of by L2CS internally. After the successful execution of this call by both participants, only one end of the payment channel is funded for both contracts.

### Confirm Channel:

confirmChannel(address_of_contract_in_partners_shard)

After both of them have locked their funds into the smart contract, both of them can now prove to each other's shard that their partner has locked their funds too. Hence, they would share their contract address with each other. L2CS will take their partner's contract address as input and would internally use the node in the partner's shard to look at the state variables of that smart contract and match the account address and verify if it is funded with a non-zero positive balance. Once it is confirmed, L2CS internally uses that infinite account representing funds from other shards to fund the smart contract in its own shard, but at their partner's end of the channel.

Other than the main endpoints discussed earlier, L2CS has other minor endpoints which are used in the intermediate stages of the channel formation phase.
contractAddress( ): Returns the public address of the cross-shard channel smart contract deployed in its own shard. If no such contract is deployed, it sends a BAD REQUEST response.
accountAddress( ): Returns the public address of own account address. If L2CS is unable to find any accounts owned by the node, it sends a BAD REQUEST response.

fetchContractStatus( ): Returns the balance status of both ends in their own shard's cross-shard channel contract. If it fails to fetch the contract status due to various reasons, it sends an INTERNAL SERVER ERROR response.

The embodiments disclosed herein can be implemented through at least one software program running on at least one hardware device and performing network management functions to control the network elements. The network elements shown in FIG. 22 include blocks which can be at least one of a hardware device, or a combination of hardware device and software module.

The embodiment disclosed herein describes a formation and termination mechanisms for a general-purpose Cross-Chain Payment Channel (CCPC) protocol and a general-purpose Cross-Shard Payment Channel (CSPC) protocol. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs. [If this para is not applicable, remove it]

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. A method for forming and terminating payment channels between two distinct ledger environments, wherein the method comprises:
establishing a payment channel between a first participant of a first distinct ledger and a second participant of a second distinct ledger in the blockchain system, for enabling off-chain transactions; and
terminating the payment channel and releasing a plurality of tokens in the blockchain system on one or more of the first participant and the second participant deciding to leave the payment channel.

2. The method as claimed in claim 1, wherein the first distinct ledger is a first shard and the second distinct ledger is a second shard within a single blockchain.

3. The method as claimed in claim 1, wherein the first distinct ledger is a first blockchain and the second distinct ledger is a second blockchain, wherein the first blockchain and the second blockchain belong to two distinct blockchain networks.

4. The method as claimed in claim 1, wherein establishing the payment channel comprises:
broadcasting a proposed funding transaction between the first participant and the second participant, after the first participant and the second participant mutually agree on a balance of the payment channel off-chain,
wherein the proposed funding transaction comprises a balance proof, wherein the balance proof comprises balance of each of the first participant and the second participant and the digital signatures, and
wherein the balance proof in the proposed funding transaction in the first distinct ledger is to be signed by the second participant or by both of the first participant and the second participant, and the balance proof in the proposed funding transaction in the second distinct ledger is to be signed by the first participant or by both the first participant and the second participant;
locking the plurality of tokens in the proposed funding transaction for a pre-defined time period, wherein the pre-defined time period is defined in terms of number of blocks;
one of communicating the balance proof by the first participant and the second participant, the balance proof to each other, or obtaining the balance proof from the distinct ledger of the partner and sending a confirm funding transaction to their respective distinct ledger with a valid proof, wherein a waiting period is started by the blockchain system for the confirm funding transaction to be submitted by the first and the second distinct ledgers; and
establishing the payment channel once a valid confirm funding transaction is committed on each of the first and the second distinct ledgers, wherein the formation of the payment channel in the form of the confirm funding transaction comprises broadcasting Merkle proof of the first and the second participants to the distinct ledger of their partner's.

5. The method as claimed in claim 4, wherein, in the event of the proposed funding transaction confirmed in one of the first and the second distinct ledgers and timing out in the other distinct ledger, wherein the other distinct ledger is one of the first and the second distinct ledgers where the proposed funding transaction has timed out, wherein the method comprises allowing a smart contract to release a funding discarded event by calling a dedicated function, wherein the dedicated function releases locked tokens for the participant where the timeout of the proposal occurred.

6. The method as claimed in claim 1, wherein terminating the payment channel by one of the first participant and the second participant comprises:
initiating a withdrawal by a proposer, with an initiate withdraw transaction, wherein the initiate withdraw transaction comprises a valid and up-to-date balance proof signed by the proposer, wherein the proposer is one of the first participant and the second participant wishing to withdraw from the payment channel, wherein a proposal to withdraw from the payment channel is treated as a pending withdraw transaction in the distinct ledger that has not initiated the withdrawal;
implementing a waiting period to allow the participant that has not initiated the withdrawal to propose another valid balance proof, wherein the waiting period corresponds to a transaction made after at least K blocks from the pending withdraw transaction;
releasing the locked tokens and terminating the payment channel, once the confirm withdraw transaction is committed on the distinct ledger that has not initiated the withdrawal; and
challenging the pending withdraw transaction, in case the participant that has not initiated the withdrawal suspects malicious withdrawal request from the proposer, wherein challenging the pending withdraw transaction comprises generating a withdrawal discarded event on presenting a valid balance proof in the challenge transaction.

7. The method as claimed in claim 1, wherein terminating the payment channel by both the first and the second participants comprises:
initiating a propose withdraw request in their respective distinct ledgers, using the same balance proof and presenting a partially completed withdrawal by sharing the Merkel proof of the proposal with each other, wherein, in case of the first and the second distinct ledgers being two different blockchains, a relay node system sends across Merkle root information from one blockchain to the other; and
providing a final confirmation of the withdraw request by including the Merkle proof of the partial confirmation from the other distinct ledger.

8. The method as claimed in claim 1, wherein the method comprises:
transferring tokens by utilizing intermediate payment channels when the first participant and the second participant are not connected directly by a payment channel;
initiating a mediated transfer by a sender, by locking a plurality of tokens in a payment channel with an intermediary node and providing a hash-locked balance proof to the intermediary node, wherein the sender is one of the first participant and the second participant; and
claiming the plurality of token by a recipient, by revealing a pre-image of the hash lock within a pre-defined time period.

9. A method for forming and terminating payment channel between shards in a blockchain system, the method comprising:
initiating a proposed funding transaction between a first participant of a first shard and a second participant of a second shard, wherein initiating the proposed funding transaction comprises locking specified number of tokens, wherein the specified number of tokens includes number of tokens proposed by the two participants;
exchanging balance proofs to validate the locked tokens;
confirming the proposed funding transaction between the first participant and the second participant by securing the locked tokens for a defined time period, wherein confirming the proposed funding transaction comprises using Merkle Proof, wherein the Merkle Proof is verified using a root hash of a block containing the proposed funding transaction;
communicating formation of the proposed funding transaction on each of the first shard and the second shard, indicating the successful formation of the cross shard payment channel (CSPC);
initiating a withdrawal request by one of the first participant and the second participant, indicating unlocking of a specified amount of tokens;
sharing and validating Merkle Proofs for withdrawal transactions to prove the authenticity and legitimacy of the withdrawal request, wherein initiating the withdrawal request comprises proposing the withdrawal request by one or more of the first participant and the second participant;
releasing the locked tokens based on validated proofs, following one of a predefined block distance and challenge period; and
allowing the first and the second participant to challenge malicious withdrawal attempts, using Merkle Proofs to demonstrate proof of rejection.

10. The method as claimed in claim 9, wherein the method comprises discarding the proposed funding transaction and the CSPC, if one of the first and the second participant fails to show valid proof with confirm funding transaction within the defined time period.

11. The method as claimed in claim 9, wherein the method comprises requesting a message indicating discarding of the proposed funding transaction by one of the first participant and the second participant in case of timing out of the proposed funding transaction in one of the first shard and the second shard.

12. The method as claimed in claim 9, wherein one of the first participant and the second participant initiates the withdrawal request, comprising:
initiating an ‘Initiate Withdraw’ transaction by the proposing participant on their native shard, including a valid balance proof;
coordinating the same withdrawal process in the shard corresponding to the proposing participant;
confirming the withdrawal by generating a ‘Confirm Withdraw’ transaction; and
ensuring that the confirming transaction is committed after a predefined number of blocks by verifying a block distance between withdrawal transactions, wherein the method comprises enabling the first participant and the second participant to challenge and handle malicious withdrawal attempts by presenting Merkle Proofs to prove the rejection of fraudulent withdrawal transactions.

13. The method as claimed in claim 9, wherein both the first participant and the second participant cooperatively propose the withdrawal, comprising:
initiating a ‘Propose Withdraw’ request in their respective shards with the same balance proof;
sharing Merkle Proofs of the proposal with each other to ensure consistency;
verifying a block distance between the withdrawal transactions on both the first shard and the second shard;
facilitating a ‘Final Confirmation’ by the first participant and the second participant including the Merkle proof of the ‘Partial Confirmation’ from one of the first shard and the second shard; and
validating that a predefined block distance is met for a successful withdrawal confirmation.

14. A method for forming and terminating Cross Chain Payment Channels (CCPC) between a first blockchain network and a second blockchain network, comprising:
initiating one or more proposed funding transactions on the first blockchain network and the second blockchain network involving a plurality of participants, locking specified amounts of tokens, wherein the method comprises allowing one or more participants to create off-chain transactions within the CCPC, including multi-token transfers, by exchanging updated balance proofs securely;
exchanging one or more balance proofs to validate the locked tokens on the first blockchain network and the second blockchain network;
confirming the proposed one or more proposed funding transactions in the first blockchain network and the second blockchain network, securing the locked funds for a predefined time period;
communicating a “CCPC Formed” transaction on each of the first and the second blockchain networks, indicating the successful formation of the CCPC;
initiating a withdrawal request by a participant on both the first and second blockchain networks, for unlocking the specified amounts of tokens.
sharing and validating Merkle Proofs for withdrawal transactions to prove the authenticity and legitimacy of the withdrawal request on both the first and second blockchain networks;
releasing the locked tokens based on validated proofs, following one of a predefined block distance, or challenge period;
allowing the one or more participants to challenge malicious or fraudulent withdrawal attempts, using Merkle Proofs to demonstrate proof of rejection.

15. The method of claim 14, further comprising utilizing relay nodes to validate the existence and authenticity of transactions on each of the first and the second blockchain networks.

16. The method of claim 14, the method comprising supporting the blockchain networks that use Turing-complete smart contracts for secure cross-chain communication and token locking.

17. A blockchain system for forming and terminating payment channels between two distinct ledger environments, wherein the blockchain system comprises:
a processor coupled to a memory, wherein the processor is configured to:
form a payment channel between a first participant of a first distinct ledger and a second participant of a second distinct ledger in the blockchain system, for enabling off-chain transactions, wherein the first distinct ledger is one of a first shard and a first blockchain and the second distinct ledger is one of a second shard and a second blockchain; and
terminate the payment channel and releasing a plurality of tokens in the blockchain system on one or more of the first participant and the second participant deciding to leave the payment channel.

18. The blockchain system as claimed in claim 17, wherein the processor is configured to establishing the payment channel by:
broadcasting a proposed funding transaction between the first participant and the second participant, after the first participant and the second participant mutually agree on a balance of the payment channel off-chain,
wherein the proposed funding transaction comprises a balance proof, wherein the balance proof comprises balance of each of the first participant and the second participant and the digital signatures, wherein, in the event of the proposed funding transaction confirmed in one of the first and the second distinct ledgers and timing out in the other distinct ledger, wherein the other distinct ledger is one of the first and the second distinct ledgers where the proposed funding transaction has timed out, wherein the processor is configured to allow a smart contract to release a funding discarded event by calling a dedicated function, wherein the dedicated function releases locked tokens for the participant where the timeout of the proposal occurred, and
wherein the balance proof in the proposed funding transaction in the first distinct ledger is to be signed by the second participant or by both of the first participant and the second participant, and the balance proof in the proposed funding transaction in the second distinct ledger is to be signed by the first participant or by both the first participant and the second participant;
locking the plurality of tokens in the proposed funding transaction for a pre-defined time period, wherein the pre-defined time period is defined in terms of number of blocks;
one of communicating the balance proof by the first participant and the second participant, the balance proof to each other, or obtaining the balance proof from the distinct ledger of the partner and sending a confirm funding transaction to their respective distinct ledger with a valid proof, wherein a waiting period is started by the blockchain system for the confirm funding transaction to be submitted by the first and the second distinct ledgers; and
establishing the payment channel once a valid confirm funding transaction is committed on each of the first and the second distinct ledgers, wherein the formation of the payment channel in the form of the confirm funding transaction comprises broadcasting Merkle proof of the first and the second participants to the distinct ledger of their partner's.

19. The blockchain system as claimed in claim 17, wherein the processor is configured to terminate the payment channel by one of the first participant and the second participant by:
enabling initiation of a withdrawal by a proposer, with an initiate withdraw transaction, wherein the initiate withdraw transaction comprises a valid and up-to-date balance proof signed by the proposer, wherein the proposer is one of the first participant and the second participant wishing to withdraw from the payment channel, wherein a proposal to withdraw from the payment channel is treated as a pending withdraw transaction in the distinct ledger that has not initiated the withdrawal;
implementing a waiting period to allow the participant that has not initiated the withdrawal to propose another valid balance proof, wherein the waiting period corresponds to a transaction made after at least K blocks from the pending withdraw transaction;
releasing the locked tokens and terminating the payment channel, once the confirm withdraw transaction is committed on the distinct ledger that has not initiated the withdrawal; and
challenging the pending withdraw transaction, in case the participant that has not initiated the withdrawal suspects malicious withdrawal request from the proposer, wherein challenging the pending withdraw transaction comprises generating a withdrawal discarded event on presenting a valid balance proof in the challenge transaction.

20. The blockchain system as claimed in claim 17, wherein the processor is configured to terminate the payment channel by both the first and the second participants by:
initiating a propose withdraw request in their respective distinct ledgers, using the same balance proof and presenting a partially completed withdrawal by sharing the Merkel proof of the proposal with each other, wherein, in case of the first and the second distinct ledgers being two different blockchains, a relay node system sends across Merkle root information from one blockchain to the other; and
providing a final confirmation of the withdraw request by including the Merkle proof of the partial confirmation from the other distinct ledger.
